(19) United States
(12) Patent Application Publication
(10) Pub. No.: US 2022/0356074 A1
(43) Pub. Date: Nov. 10, 2022

(54) POTASSIUM HEXAFLUOROMANGANATE, AND METHOD FOR PRODUCING MANGANESE-ACTIVATED COMPLEX FLUORIDE FLUORESCENT BODY

(71) Applicant: DENKA COMPANY LIMITED, Tokyo (JP)

(72) Inventors: Masayoshi ICHIKAWA, Tokyo (JP); Motoi TANAKA, Tokyo (JP); Kazuhiro ITOH, Tokyo (JP)

(73) Assignee: DENKA COMPANY LIMITED, Tokyo (JP)

(21) Appl. No.: 17/623,521

(22) PCT Filed: Aug. 4, 2020
(86) PCT No.: PCT/JP2020/029901

§ 371 Date: Dec. 28, 2021

(30) Foreign Application Priority Data
Aug. 9, 2019 (JP) 2019-147538

(51) Int. Cl. C01G 45/06; C09K 11/57; C09K 11/61

(52) U.S. Cl. CPC C01G 45/06; C09K 11/57; C09K 11/616

(57) ABSTRACT

A potassium hexafluoromanganate is represented by General Formula: K₂MnF₆, and a diffuse reflectance with respect to light having a wavelength of 310 nm is 20% or more.

### TECHNICAL FIELD

The present disclosure relates to potassium hexafluoromanganate and a method for producing a manganese-activated complex fluoride phosphor.

### BACKGROUND ART

Light emitting diodes (LEDs) are widely used in image display devices, display backlights, lighting, and the like. In an image display device using an LED, an LED having a blue light emitting diode and a yellow phosphor is generally used. In recent years, due to the demand for higher color rendering of image display devices, green phosphors and red phosphors have come to be used in combination instead of yellow phosphors.

Phosphors generally have a structure in which an element serving as a luminescence center is solid-dissolved in a host crystal. Examples of red phosphors include a complex fluoride phosphor in which Mn⁴⁺ is solid-dissolved as a luminescence center in a host crystal composed of complex fluoride. Examples of the complex fluoride phosphor include a manganese-activated complex fluoride phosphor (hereinafter, also referred to as a KSF phosphor) represented by General Formula K₂SiF₆:Mn⁴⁺ in which Mn⁴⁺ is solid-dissolved and activated in a host crystal containing complex fluoride. The KSF phosphor is attracting attention because it is efficiently excited by blue light and has an emission spectrum with a narrow half-width.

As a method for producing the KSF phosphor, a method for producing a phosphor by preparing a plurality of types of hydrofluoric acid aqueous solutions in which a raw material having a constituent element of a phosphor is dissolved in a hydrofluoric acid aqueous solution, and mixing and reacting these, alternatively, reacting the above-mentioned hydrofluoric acid aqueous solution and a solid raw material (for example, Patent Literature 1); a method for producing a phosphor by preparing a plurality of types of hydrofluoric acid aqueous solutions in which a raw material having a constituent element of a phosphor is dissolved in a hydrofluoric acid aqueous solution, mixing and reacting these, and further adding a solvent that becomes a poor solvent for the phosphor to precipitate the phosphor (for example, Patent Literature 2); and the like are known, for example.

Potassium hexafluoromanganate represented by General Formula K²MnF₆ is used as a raw material used in a method for producing the above-mentioned KSF phosphor. Potassium hexafluoromanganate is generally prepared in one step in the process of producing KSF phosphors. Examples of methods for preparing potassium hexafluoromanganate include a Bode method (Non-Patent Literature 1) and an electrolytic precipitation method.

### CITATION LIST

### Patent Literature

[Patent Literature 1] Japanese Unexamined Patent Publication No. 2010-209331
[Patent Literature 2] U.S. Pat. No. 3,576,756

### Non-Patent Literature

[Non-Patent Literature 1] H. Bode, H. Jenssen, and F. Bandte, Angew. Chem., 1953, 304

### SUMMARY OF INVENTION

### Technical Problem

An object of the present disclosure is to provide potassium hexafluoromanganate capable of producing a phosphor having excellent internal quantum efficiency. Another object of the present disclosure is to provide a method for producing a manganese-activated complex fluoride phosphor having excellent internal quantum efficiency.

### Solution to Problem

One aspect of the present disclosure provides potassium hexafluoromanganate in which the potassium hexafluoromanganate is represented by General Formula: K₂MnF₆, and a diffuse reflectance with respect to light having a wavelength of 310 nm is 20% or more.

The above-mentioned potassium hexafluoromanganate may provide a phosphor having excellent internal quantum efficiency. The reason why the obtained phosphor has excellent internal quantum efficiency when potassium hexafluoromanganate in which a diffuse reflectance with respect to light having a wavelength of 310 nm is 20% or more is used as a raw material is not necessarily clear. However, the inventors of the present invention speculate as follows. A region having a wavelength of around 310 nm is a region in which absorption is observed when an element such as Mn²⁺ that does not contribute to fluorescent emission is contained in the phosphor. In addition, when the diffuse reflectance of the region is high, this means that the proportion accounted for an element such as Mn²⁺ in manganese constituting the potassium hexafluoromanganate is small, and the proportion accounted for an element that is the center of light emission (herein, Mn⁴⁺) in the manganese is high. That is, it is thought that, when the potassium hexafluoromanganate in which a diffuse reflectance with respect to light having a wavelength of 310 nm is 20% or more is used as a raw material, it is possible to produce a manganese-activated complex fluoride phosphor in which a proportion of Mn⁴⁺ is high, and this phosphor also has excellent internal quantum efficiency.

In the potassium hexafluoromanganate, a diffuse reflectance with respect to light having a wavelength of 550 nm may be 55% or more. The region near the wavelength of 550 nm is a region in which absorption is observed when an element such as Mn³⁺ that does not contribute to fluorescent emission is contained in a phosphor, and when the diffuse reflectance of the region is high, this shows that the proportion accounted for an element (herein, Mn⁴⁺) that is the center of light emission in the manganese is high. That is, it is thought that, when the potassium hexafluoromanganate in which a diffuse reflectance with respect to light having a wavelength of 550 nm is 55% or more is used as a raw material, it is possible to produce a manganese-activated complex fluoride phosphor in which a proportion of Mn⁴⁺ is high, and this phosphor may also have a superior internal quantum efficiency.

One aspect of the present disclosure provides a method for producing a manganese-activated complex fluoride phosphor, the method including dissolving the above-mentioned potassium hexafluoromanganate in a hydrofluoric acid aqueous solution.

Since the above-mentioned method for producing a manganese-activated complex fluoride phosphor uses the above-mentioned potassium hexafluoromanganate as a raw material, it is possible to produce a complex fluoride phosphor having excellent internal quantum efficiency.

### Advantageous Effects of Invention

According to the present disclosure, it is possible to provide potassium hexafluoromanganate capable of producing a phosphor having excellent internal quantum efficiency. According to the present disclosure, it is possible to further provide a method for producing a manganese-activated complex fluoride phosphor having excellent internal quantum efficiency.

### BRIEF DESCRIPTION OF DRAWINGS

FIG. 1 is a diagram showing a diffuse reflectance spectrum of potassium hexafluoromanganate prepared in Example 1.

FIG. 2 is a diagram showing a diffuse reflectance spectrum of potassium hexafluoromanganate prepared in Example 2.

### DESCRIPTION OF EMBODIMENTS

Hereinafter, embodiments of the present disclosure will be described. However, the following embodiments are examples for explaining the present disclosure and are not intended to limit the present disclosure to the following contents.

Unless otherwise specified, materials exemplified in the present specification may be used alone or in combination of two or more kinds. When a plurality of substances corresponding to each of components in a composition are present, the content of each of the components in the composition means the total amount of the plurality of substances present in the composition unless otherwise specified.

In one embodiment of potassium hexafluoromanganate, the potassium hexafluoromanganate is represented by General Formula: K₂MnF₆, and a diffuse reflectance with respect to light having a wavelength of 310 nm is 20% or more. The potassium hexafluoromanganate may reduce the absorption of unnecessary excitation light in a phosphor produced from the potassium hexafluoromanganate. That is, the potassium hexafluoromanganate is useful as a raw material of a manganese-activated complex fluoride phosphor. Examples of the manganese-activated complex fluoride phosphor include manganese-activated potassium silicate hexafluoride (K₂SiF₆:Mn⁴⁺), K₂GeF₆:Mn⁴⁺, and K₂TiF₆:Mn⁴⁺.

In the composition of the constituent elements of the potassium hexafluoromanganate, potassium and manganese can be quantitatively analyzed by an ICP-MS method. Furthermore, in the composition of the constituent elements of the potassium hexafluoromanganate, fluorine can be analyzed by an ion chromatography method. That is, by the above-mentioned measurement, the potassium hexafluoromanganate can be identified, and the composition thereof can be confirmed to be represented by K₂MnF₆.

In the potassium hexafluoromanganate, the diffuse reflectance with respect to light having a wavelength of 310 nm is 20% or more, but the diffuse reflectance may be 25% or more, 30% or more, or 35% or more, for example. When the diffuse reflectance with respect to light having a wavelength of 310 nm is in the above-mentioned range, it is possible to further improve the internal quantum efficiency of a complex fluoride phosphor produced using the potassium hexafluoromanganate as a raw material. The upper limit value of the above-mentioned diffuse reflectance may be 80% or less, 70% or less, 60% or less, or 55% or less, for example. The above-mentioned diffuse reflectance may be adjusted in the above-mentioned range, and may be 20% to 80%, 25% to 80%, 30% to 80%, or the like, for example.

In the potassium hexafluoromanganate, the diffuse reflectance with respect to light having a wavelength of 550 nm may be 55% or more, 60% or more, 65% or more, 70% or more, or 75% or more, for example. When the diffuse reflectance with respect to light having a wavelength of 550 nm is in the above-mentioned range, it is possible to further improve the internal quantum efficiency of a complex fluoride phosphor produced using the potassium hexafluoromanganate as a raw material. The upper limit value of the diffuse reflectance is not particularly limited and may be 100%. The above-mentioned diffuse reflectance may be adjusted in the above-mentioned range, and may be 55% to 100%, 60% to 100%, or the like, for example.

In the potassium hexafluoromanganate, the diffuse reflectance with respect to light having a wavelength of 850 nm may be 90% or more, 92% or more, 95% or more, or 98% or more, for example. When the diffuse reflectance with respect to light having a wavelength of 850 nm is in the above-mentioned range, it is possible to further improve the internal quantum efficiency of a complex fluoride phosphor produced using the potassium hexafluoromanganate as a raw material. The upper limit value of the diffuse reflectance is not particularly limited and may be 100%. The above-mentioned diffuse reflectance may be adjusted in the above-mentioned range, and may be 90% to 100%, 92% to 100%, 95% to 100%, 98% to 100%, or the like, for example.

In the present specification, the diffuse reflectance means a value determined from the diffuse reflectance spectrum of the potassium hexafluoromanganate measured by using an ultraviolet-visible spectrophotometer (manufactured by JASCO Corporation, trade name: V-550). Specifically, the diffuse reflectance is obtained by measurement by an operation described in Examples described in the present specification.

The above-mentioned potassium hexafluoromanganate can be produced by the following method, for example. One embodiment of a method for producing potassium hexafluoromanganate includes: preparing a hydrofluoric acid aqueous solution in which potassium hexafluoromanganate is dissolved in an aqueous solution in which a concentration of hydrofluoric acid is 58% by mass or more; and adding potassium hydrogen fluoride to the hydrofluoric acid aqueous solution to reprecipitate potassium hexafluoromanganate.

Conventionally, potassium hexafluoromanganate is generally prepared in one step in the process of producing a complex fluoride phosphor, and isolating potassium hexafluoromanganate and further performing recrystallization and purification have not been performed. That is, the conventional potassium hexafluoromanganate is formed as one containing manganese of various valences and is consumed as it is as a phosphor raw material, and therefore the proportion of Mn⁴⁺ in the obtained phosphor is not necessarily high. On the other hand, in the method for producing potassium hexafluoromanganate according to the present embodiment, by dissolving potassium hexafluoromanganate in a hydrofluoric acid aqueous solution having a specific concentration or higher, and recrystallizing and purifying from this aqueous solution, the composition of manganese constituting potassium hexafluoromanganate may be prepared so that the proportion of Mn⁴⁺ is high. Accordingly, the proportion accounted for Mn of other valences such as Mn²⁺ that does not contribute to fluorescent emission in manganese constituting the obtained potassium hexafluoromanganate is reduced, and it is possible to obtain potassium hexafluoromanganate in which the diffuse reflectance with respect to light having a wavelength of 310 nm is improved.

The above-mentioned potassium hexafluoromanganate is useful as a raw material used for producing a complex fluoride phosphor. Examples of the complex fluoride phosphor include a manganese-activated complex fluoride phosphor and the like. Examples of the manganese-activated complex fluoride phosphor include manganese-activated potassium silicate hexafluoride (K₂SiF₆:Mn⁴⁺), K₂GeF₆:Mn⁴⁺, and K₂TiF₆:Mn⁴⁺.

In the production method according to the present embodiment, as potassium hexafluoromanganate to be dissolved in a hydrofluoric acid aqueous solution having a concentration of 58% by mass or more, it is possible to use potassium hexafluoromanganate that can be prepared by a conventional method such as a Bode method and an electrolytic precipitation method, for example.

In the production method according to the present embodiment, an aqueous solution in which the concentration of hydrofluoric acid is 58% by mass or more is used. The lower limit value of the concentration of hydrofluoric acid in the hydrofluoric acid aqueous solution may be 59% by mass or more, or 60% by mass or more, for example. When the lower limit value of the concentration of the hydrofluoric acid aqueous solution is in the above-mentioned range, it is possible to adjust the valence of manganese that is a constituent element of the potassium hexafluoromanganate. More specifically, by stabilizing Mn⁴⁺ in the aqueous solution and suppressing the generation of Mn of other valences such as Mn²⁺ that does not contribute to fluorescent emission, it is possible to increase the proportion of Mn⁴⁺ incorporated into the potassium hexafluoromanganate. Because Mn of other valences such as Mn²⁺ may absorb light having a wavelength of 310 nm, by reducing the proportion of Mn of other valences such as Mn²⁺, it is possible to further improve the diffuse reflectance of the obtained potassium hexafluoromanganate with respect to light having a wavelength of 310 nm. The upper limit value of the concentration of hydrofluoric acid in the hydrofluoric acid aqueous solution is not particularly limited, but may be 70% by mass or less, or 65% by mass or less, for example. When the upper limit value of the concentration of the hydrofluoric acid aqueous solution is in the above-mentioned range, operability is excellent. The concentration of hydrofluoric acid in the hydrofluoric acid aqueous solution can be adjusted in the above-mentioned range, and may be 58% to 70% by mass or may be 60% to 65% by mass, for example.

The process of adding potassium hydrogen fluoride to the above-mentioned hydrofluoric acid aqueous solution to precipitate potassium hexafluoromanganate is preferably performed over a certain period of time while stirring the aqueous solution. The stirring time may be adjusted according to the volume of the solution, the pH of the solution, the blending amount of potassium hydrogen fluoride, and the like. From the viewpoint of reactivity and productivity, the stirring time may be about 10 minutes to 12 hours, and is preferably 1 to 3 hours. The stirring may be magnetic stirring, mechanical stirring, or the like, for example. The stirring speed may be adjusted according to the volume of the solution, the blending amount of potassium hydrogen fluoride, and the like. The stirring speed is not particularly limited, but may be 200 to 500 rpm, for example.

In the process of adding potassium hydrogen fluoride to the above-mentioned hydrofluoric acid aqueous solution to precipitate potassium hexafluoromanganate, the temperature of the hydrofluoric acid aqueous solution may be set to around room temperature. The lower limit value of the temperature of the hydrofluoric acid aqueous solution in the above-mentioned process may be, for example, higher than 5° C., 10° C. or higher, 15° C. or higher, 20° C. or higher, or 25° C. or higher from the viewpoint of improving productivity. The upper limit value of the temperature of the hydrofluoric acid aqueous solution in the above-mentioned process may be, for example, 40° C. or lower or 30° C. or lower from the viewpoint of improving the handleability of the solution in the production of the potassium hexafluoromanganate. The temperature of the hydrofluoric acid aqueous solution in the above-mentioned process can be adjusted in the above-mentioned range, and may be 10° C. to 30° C. or may be 25° C. to 30° C., for example.

In adding potassium hydrogen fluoride to the above-mentioned hydrofluoric acid aqueous solution to reprecipitate potassium hexafluoromanganate, as means for adding potassium hydrogen fluoride, for example, potassium hydrogen fluoride may be directly blended into the above-mentioned hydrofluoric acid aqueous solution, or potassium hydrogen fluoride may be blended in by separately preparing a hydrofluoric acid aqueous solution in which potassium hydrogen fluoride is dissolved, and mixing the prepared hydrofluoric acid aqueous solution to a hydrofluoric acid aqueous solution in which potassium hexafluoromanganate is dissolved. The concentration of hydrofluoric acid in the hydrofluoric acid aqueous solution at the time of dissolving potassium hydrogen fluoride may be the same as the concentration of hydrofluoric acid in the hydrofluoric acid aqueous solution in which potassium hexafluoromanganate is dissolved, and is preferably 58% by mass or more, or 60% by mass or more. When potassium hydrogen fluoride is blended in as a hydrofluoric acid aqueous solution, the concentration of potassium hydrogen fluoride in the hydrofluoric acid aqueous solution may be 17% to 26% by mass, for example.

In the present embodiment, the lower limit value of the blending amount of potassium hydrogen fluoride is 200 parts by mass or more, 300 parts by mass or more, or 450 parts by mass or more based on 100 parts by mass of potassium hexafluoromanganate from the viewpoint of improving the yield. The upper limit value of the blending amount of potassium hydrogen fluoride is 1000 parts by mass or less, 800 parts by mass or less, or 500 parts by mass or less based on 100 parts by mass of potassium hexafluoromanganate from the viewpoint of improving the ease of handling purified potassium hexafluoromanganate. The blending amount of potassium hydrogen fluoride can be adjusted in the above-mentioned range, and may be, for example, 200 to 800 parts by mass or 200 to 500 parts by mass based on 100 parts by mass of potassium hexafluoromanganate.

One embodiment of a method for producing a manganese-activated complex fluoride phosphor includes dissolving the above-mentioned potassium hexafluoromanganate in a hydrofluoric acid aqueous solution.

As a more specific aspect of the production method, a production method including preparing a solution in which the above-mentioned potassium hexafluoromanganate is dissolved in hydrofluoric acid or a hydrofluosilicic acid aqueous solution, and a compound serving as a potassium source, a compound serving as a silicon source, and a compound serving as a fluorine source are further dissolved, and heating the solution and evaporating to dryness to obtain a manganese-activated complex fluoride phosphor is an exemplary example. Furthermore, as another more specific aspect of the production method, a production method including preparing a solution in which the above-mentioned potassium hexafluoromanganate is dissolved in hydrofluoric acid or a hydrofluosilicic acid aqueous solution, and a compound serving as a potassium source, a compound serving as a silicon source, and a compound serving as a fluorine source are further dissolved, and cooling the solution to obtain a manganese-activated complex fluoride phosphor is an exemplary example. Furthermore, as another more specific aspect of the production method, a production method including preparing a solution in which the above-mentioned potassium hexafluoromanganate is dissolved in hydrofluoric acid or a hydrofluosilicic acid aqueous solution, and a compound serving as a potassium source, a compound serving as a silicon source, and a compound serving as a fluorine source are further dissolved, adding a poor solvent for the above-mentioned manganese-activated complex fluoride phosphor to the solution to reduce the solubility of the manganese-activated complex fluoride phosphor, and precipitating the manganese-activated complex fluoride phosphor to obtain a phosphor is an exemplary example.

In the above-mentioned method for producing a manganese-activated complex fluoride phosphor, since potassium hexafluoromanganate in which the diffuse reflectance with respect to light having a wavelength of 310 nm is 20% or more, for example, potassium hexafluoromanganate in which the proportion of Mn of other valences such as Mn³⁺ is reduced is used, Mn⁴⁺ may be more efficiently supplied by the manganese-activated complex fluoride phosphor as compared to the conventional potassium hexafluoromanganate. Therefore, the obtained manganese-activated complex fluoride phosphor has excellent light emission intensity, and furthermore, it also has excellent internal quantum efficiency from the viewpoint that absorption of light at 310 nm is suppressed.

By the above-mentioned method for producing a manganese-activated complex fluoride phosphor, it is possible to produce a phosphor containing K₂SiF₆:Mn⁴⁺, and the like. The phosphor containing K₂SiF₆:Mn⁴⁺ may be a fluoride represented by K₂SiF₆, and may be one in which some of the sites of a tetravalent element are substituted with manganese. In a fluoride phosphor, some of potassium (K), silicon (Si), fluorine (F), and manganese (Mn), which are constituent elements thereof, may be substituted with other elements, and some of elements in the crystal may be missing by being substituted with elements of different valences. The other elements may be at least one selected from the group consisting of sodium (Na), germanium (Ge), titanium (Ti), and oxygen (O), for example.

The manganese-activated complex fluoride phosphor produced as described above has excellent internal quantum efficiency. The internal quantum efficiency of the manganese-activated complex fluoride phosphor may be more than 86%, 87% or more, 88% or more, 89% or more, or 90% or more. The above-mentioned manganese-activated complex fluoride phosphor may be one having superior internal quantum efficiency to the conventional manganese-activated complex fluoride phosphor, and is thus useful as a red phosphor used for LEDs, for example.

Hereinbefore, although some embodiments have been described, the explanations for the common constitutions can be applied to each other. Furthermore, the present disclosure is not limited to the above-mentioned embodiments.

### EXAMPLES

The contents of the present disclosure will be described in more detail with reference to examples and comparative examples, but the present disclosure is not limited to the following examples.

### Example 1

[Preparation of KMF (K₂MnF₆)]

1600 mL of hydrofluoric acid (concentration: 48% by mass) was weighed in a fluororesin beaker having the capacity of 2000 mL, and 516 g of a potassium hydrogen fluoride powder (manufactured by Kanto Chemical Co., Inc.) and 24.0 g of a potassium permanganate powder (manufactured by Kanto Chemical Co., Inc.) were dissolved therein to prepare a hydrofluoric acid aqueous solution. While stirring the obtained hydrofluoric acid aqueous solution with a magnetic stirrer at the stirring speed of 350 rpm, 18.25 g of a hydrogen peroxide solution (concentration: 30% by mass, manufactured by Kanto Chemical Co., Inc.) was dropwise added little by little. It was confirmed that a yellow powder began to precipitate when the dropwise addition amount of the hydrogen peroxide solution exceeded a certain amount, and the color of the solution in the beaker changed from purple.

After the solution was stirred for a while after the color changed, stirring was stopped to deposit a precipitated powder. When the precipitated powder was deposited, the supernatant was removed, methanol (manufactured by Kanto Chemical Co., Inc.) was added to the beaker, and the solution was stirred. Thereafter, stirring of the solution was stopped, the precipitated powder was deposited again, the supernatant was removed, methanol was added again, and stirring was performed. The above-mentioned operation was repeated until the solution in the beaker became neutral. When the solution in the beaker became neutral, the precipitated powder was deposited again, and the precipitated powder was recovered by filtration. The recovered precipitated powder was dried to remove methanol. By analyzing the elemental composition of the precipitated powder by an ICP-MS method and an ion chromatography method, it was confirmed that a K₂MnF₆ powder was formed. The preparation of the K₂MnF₆ powder was performed at room temperature (25° C.).

Using the K₂MnF₆ powder obtained as described above, the following operation was further performed. That is, 100 mL of hydrofluoric acid (concentration: 60% by mass) was weighed in a fluororesin beaker having the capacity of 500 mL, and 14.76 g of the K₂MnF₆ powder prepared as described above was dissolved therein to prepare a hydrofluoric acid aqueous solution. While stirring the obtained hydrofluoric acid aqueous solution with a magnetic stirrer at the stirring speed of 350 rpm, a hydrofluoric acid aqueous solution, which was prepared separately and in which 60.97 g of potassium hydrogen fluoride was dissolved in 133.4 mL of hydrofluoric acid (60% by mass), was gradually dropwise added. It was confirmed that a yellow-green powder began to precipitate when the blending amount of potassium hydrogen fluoride exceeded a certain amount.

After the solution was stirred for a while after deposition was generated in the solution, stirring was stopped to deposit a precipitated powder. When the precipitated powder was deposited, the supernatant was removed, methanol (manufactured by Kanto Chemical Co., Inc.) was added to the beaker, and the solution was stirred. Thereafter, stirring of the solution was stopped, the precipitated powder was deposited again, the supernatant was removed, methanol was added again, and stirring was performed. The above-mentioned operation was repeated until the solution in the beaker became neutral. When the solution in the beaker became neutral, the precipitated powder was deposited again, and the precipitated powder was recovered by filtration. The recovered precipitated powder was dried to remove methanol. By analyzing the elemental composition of the precipitated powder by an ICP-MS method and an ion chromatography method, it was confirmed that a K₂MnF₆ powder of Example 1 was obtained. The preparation of the K₂MnF₆ powder was performed at room temperature (25° C.).

### Example 2

[Preparation of KMF (K₂MnF₆)]

Using the K₂MnF₆ powder (powder before performing the operation using hydrofluoric acid (concentration: 60% by mass)) which was temporarily prepared using hydrofluoric acid (concentration: 48% by mass) in Example 1, the subsequent operation was further performed to prepare a K₂MnF₆ powder.

That is, 100 mL of hydrofluoric acid (concentration: 60% by mass) was weighed in a fluororesin beaker having the capacity of 500 mL, and 14.57 g of the K₂MnF₆ powder prepared as described above was dissolved therein to prepare a hydrofluoric acid aqueous solution. While stirring the obtained hydrofluoric acid aqueous solution with a magnetic stirrer at the stirring speed of 350 rpm, the hydrofluoric acid aqueous solution in which 46.9 g of a potassium hydrogen fluoride powder (manufactured by Kanto Chemical Co., Inc.) was dissolved was gradually dropwise added. It was confirmed that a yellow-green powder began to precipitate when the blending amount of potassium hydrogen fluoride exceeded a certain amount.

After the solution was stirred for a while after deposition was generated in the solution, stirring was stopped to deposit a precipitated powder. When the precipitated powder was deposited, the supernatant was removed, methanol (manufactured by Kanto Chemical Co., Inc.) was added to the beaker, and the solution was stirred. Thereafter, stirring of the solution was stopped, the precipitated powder was deposited again, the supernatant was removed, methanol was added again, and stirring was performed. The above-mentioned operation was repeated until the solution in the beaker became neutral. When the solution in the beaker became neutral, the precipitated powder was deposited again, and the precipitated powder was recovered by filtration. The recovered precipitated powder was dried to remove methanol. By analyzing the elemental composition of the precipitated powder by an ICP-MS method and an ion chromatography method, it was confirmed that a K₂MnF₆ powder of Example 2 was obtained. The preparation of the K₂MnF₆ powder was performed at room temperature (25° C.).

### Comparative Example 1

The K₂MnF₆ powder (powder before performing the operation using hydrofluoric acid (concentration: 60% by mass)) which was temporarily prepared using hydrofluoric acid (concentration: 48% by mass) in Example 2 was used as a K₂MnF₆ powder of Comparative Example 1.

<Measurement of Diffuse Reflectance of K₂MnF₆ Powder>

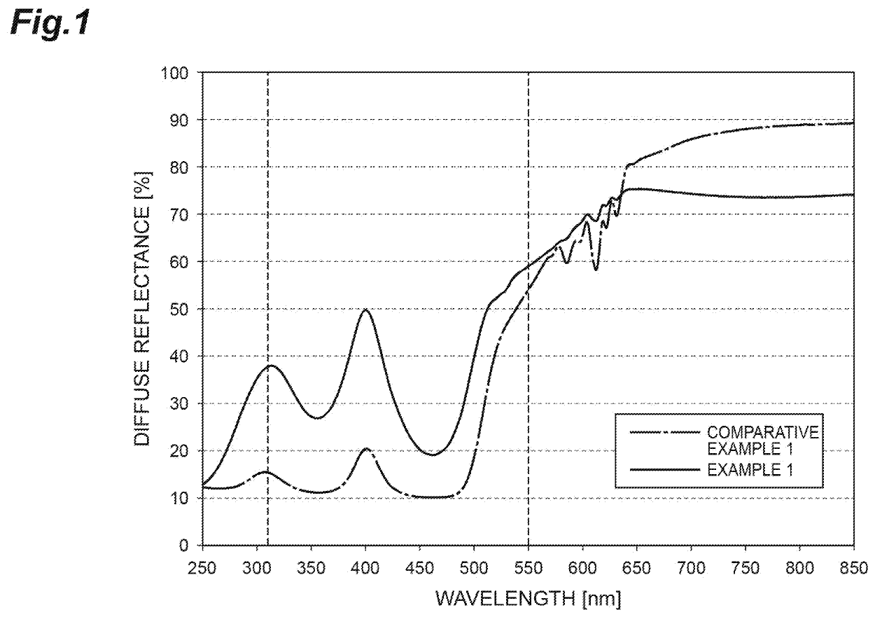

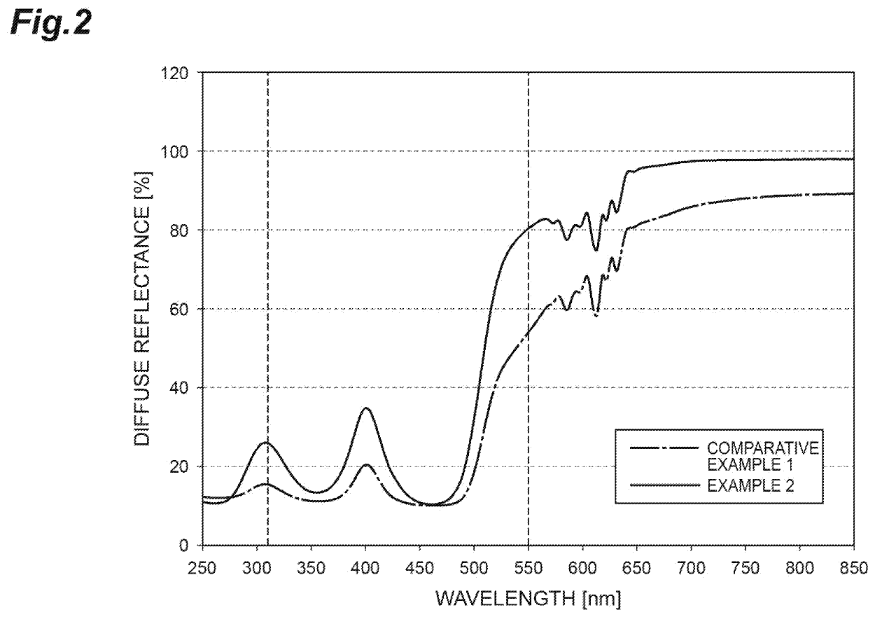

The diffuse reflectance of each of the K₂MnF₆ powders of Examples 1 and 2 and Comparative Example 1 was measured, and diffuse reflectances with respect to light having wavelengths of 310 nm and 550 nm were determined. The diffuse reflectances were measured using an ultraviolet-visible spectrophotometer (manufactured by JASCO Corporation, trade name: V-550). Baseline correction was performed with a standard reflective plate (Spectralon), and a solid sample holder filled with the K₂MnF₆ powder to be measured was attached to perform measurement of the diffuse reflectance in the wavelength range of 250 to 850 nm. Table 1 shows the results. In addition, the diffuse reflectance spectra of Examples 1 and 2 are shown in FIG. 1 and FIG. 2, respectively. The diffuse reflectance spectrum of Comparative Example 1 is also shown together in FIG. 1 and FIG. 2 for comparison.

<Evaluation of K₂MnF₆ Powder as Raw Material for Producing Manganese-Activated Complex Fluoride Phosphor>

Using each of the K₂MnF₆ powders of Examples 1 and 2 and Comparative Example 1, a manganese-activated complex fluoride phosphor was produced as described later. The internal quantum efficiency of the obtained manganese-activated complex fluoride phosphor was measured. Table 1 shows the results.

[Production of Manganese-Activated Complex Fluoride Phosphor]

First, 200 mL of hydrofluoric acid (concentration: 55% by mass, manufactured by Stella Chemifa Corporation) was weighed in a fluororesin beaker having the capacity of 500 mL, and 25.6 g of a potassium hydrogen fluoride powder (FUJIFILM Wako Pure Chemical Corporation) was dissolved therein to prepare a hydrofluoric acid aqueous solution. While stirring the obtained hydrofluoric acid aqueous solution, 6.9 g of a silicon dioxide powder (manufactured by Denka Company Limited, trade name: FB-50R) and 1.2 g of the above-mentioned K₂MnF₆ powder were added. It was visually confirmed that a yellow powder (compound represented by K₂SiF₆:Mn⁴⁺) began to be generated as soon as the silicon dioxide powder was added to the solution. When the silicon dioxide powder was added to the solution, the solution temperature rose due to the generation of heat of the solution, but reached the maximum temperature about 3 minutes after the start of adding the silicon dioxide powder, and thereafter, the solution temperature dropped to room temperature. It is thought that this is due to the completion of dissolution of the silicon dioxide powder.

After the silicon dioxide powder was completely dissolved, the solution was stirred for a while to complete the precipitation of the yellow powder. Stirring was terminated, and the solution was left to stand to deposit the yellow powder. Thereafter, the supernatant was removed, and the yellow powder was washed with hydrofluoric acid (concentration: 24% by mass, manufactured by Stella Chemifa Corporation) and methanol (manufactured by Kanto Chemical Co., Inc.). After washing, the yellow powder was recovered by filtration. After the recovered yellow powder was dried, it was classified using a nylon sieve having the opening of 75 μm to obtain 20.3 g of a yellow powder KSF (manganese-activated complex fluoride phosphor) as a powder passed through the sieve. The volume median diameter (D50) of the KSF was 28 μm.

[Measurement of Internal Quantum Efficiency of Manganese-Activated Complex Fluoride Phosphor]

The internal quantum efficiency of the manganese-activated complex fluoride phosphor prepared using the K₂MnF₆ powders of Examples 1 and 2 and Comparative Example 1 was measured using a spectroscope (manufactured by Otsuka Electronics Co., Ltd., trade name: MCPD-7000). The internal quantum efficiency is internal quantum efficiency when the phosphor is excited by using near ultraviolet light having a wavelength of 455 nm.

First, a standard reflective plate (manufactured by Labsphere, Inc., trade name: Spectralon) having the reflectance of 99% was set in the side surface opening part (φ10 mm) of the integrating sphere (φ60 mm) Monochromatic light dispersed at the wavelength of 455 nm from a light emitting source (Xe lamp) was introduced into the integrating sphere by an optical fiber, and the spectrum of the reflected light was measured by a spectroscope. At that time, the number of excitation light photons (Qex) was calculated from the spectrum in the wavelength range of 450 to 465 nm.

Next, one, in which a concave type cell was filled with a phosphor so that a surface became smooth, was set in the opening part of the integrating sphere and irradiated with the above-mentioned monochromatic light having a wavelength of 455 nm, and the spectrum of the excited reflected light and fluorescence was measured by the above-mentioned spectroscope. From the obtained spectral data, the number of excited reflected light photons (Qref) and the number of fluorescent photons (Qem) were calculated. The number of excited reflected light photons was calculated in the same wavelength range as the number of excitation light photons, and the number of fluorescent photons was calculated in the range of 465 to 800 nm.

The internal quantum efficiency (=Qem/(Qex−Qref)×100) was calculated from the obtained three types of photon numbers Qex, Qref, and Qem.

TABLE 1

| | | | | Comparative |
|---|---|---|---|---|
| | | Example 1 | Example 2 | Example 1 |
| Diffuse | 310 nm | 37.8 | 25.9 | 15.4 |
| reflectance [%] | 550 nm | 59.0 | 80.3 | 54.0 |

| | | | |
|---|---|---|---|
| Internal quantum efficiency | 87 | 91 | 86 |
| [%] | | | |

As shown in Table 1, it was confirmed that the manganese-activated complex fluoride phosphors, which were produced using the potassium hexafluoromanganate powders of Examples 1 and 2 in which the diffuse reflectance with respect to light having a wavelength of 310 nm was 20% or more as a raw material, have excellent internal quantum efficiency.

### INDUSTRIAL APPLICABILITY

According to the present disclosure, it is possible to provide potassium hexafluoromanganate capable of producing a phosphor having excellent internal quantum efficiency. According to the present disclosure, it is possible to further provide a method for producing a manganese-activated complex fluoride phosphor having excellent internal quantum efficiency.

1. Potassium hexafluoromanganate,
where the potassium hexafluoromanganate is represented by General Formula: K₂MnF₆, and
a diffuse reflectance with respect to light having a wavelength of 310 nm is 20% or more.

2. The potassium hexafluoromanganate according to claim 1, wherein
a diffuse reflectance with respect to light having a wavelength of 550 nm is 55% or more.

3. A method for producing a manganese-activated complex fluoride phosphor, the method comprising dissolving the potassium hexafluoromanganate according to claim 1 in a hydrofluoric acid aqueous solution.

4. A method for producing a manganese-activated complex fluoride phosphor, the method comprising dissolving the potassium hexafluoromanganate according to claim 2 in a hydrofluoric acid aqueous solution.
